(19) United States
(12) Patent Application Publication
(10) Pub. No.: US 2006/0007402 A1
(43) Pub. Date: Jan. 12, 2006

(54) Illumination lens system and projection system including the same

(75) Inventor: Kee-uk Jeon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/171,232

(22) Filed: Jul. 1, 2005

(30) Foreign Application Priority Data
Jul. 6, 2004 (KR) 10-2004-0052337

(51) Int. Cl. G03B 21/00

(52) U.S. Cl. 353/31

(57) ABSTRACT

An illumination lens system and a projection system including the same are provided. The illumination lens system employed in the projection system condenses a beam emitted from a light source onto a display device that forms an image. The illumination lens system includes: first through third lens groups, the second lens group including a double lens having a first lens with a highly variable negative refractive power and a second lens having a low variable positive refractive power. The illumination lens system can reduce chromatic aberration without using an aspherical lens, thereby reducing manufacturing expenses.

### BACKGROUND OF THE INVENTION

This application claims the benefit of Korean Patent Application No. 10-2004-0052337, filed on Jul. 6, 2004, in the Korean Intellectual Property Office, the disclosure of which is incorporated herein in its entirety by reference.

1. Field of the Invention

Apparatuses consistent with the present invention relate to an illumination lens system and a projection system including the same, and more particularly to an illumination lens system, in which chromatic aberration and manufacturing expenses are reduced, and a projection system including the illumination lens system.

2. Description of the Related Art

Projection systems are generally classified into three-panel projection systems and single-panel projection systems depending on the number of display devices used to turn pixels on and off to control light emitted from a light source. The light source is a high-powered lamp which produces a color image. In a single-panel projection system, the structure of the optical system can be made smaller, in comparison to a three-panel projection system, but white light is separated into red (R), green (G), and blue (B) colors using a sequential method. Thus, the light efficiency of a single-panel projection system is ⅓ the light efficiency of a three-panel projection system. Therefore, efforts for increasing the light efficiency of single-panel projection systems have been made.

In a conventional single-panel projection system, a beam irradiated from a white light source is separated into RGB color beams using a color filter, and the RGB beams are sequentially transferred to a display device. The display device operates sequentially and forms an image.

As shown in FIG. 1A, a conventional single-panel projection system includes a light source 100; a color wheel 115 that splits a beam emitted from the light source 100 into RGB color beams; an integrator 117 which shapes the RGB beams that have passed through the color wheel 115; a total reflection prism 125 which totally reflects the RGB beams that have passed through the integrator 117; and a display device 122 which receives the RGB beams reflected by the total reflection prism 125, processes the RGB beams according to an input image signal, and forms a color image. The system further includes a projection lens unit 130 which enlarges and projects the color image formed by the display device 122 onto a screen.

An illumination lens system 120 which condenses the RGB beams that pass through the integrator 117 is disposed along a light path between the integrator 117 and the total reflection prism 125.

The total reflection prism 125 includes an incidence prism 125a which totally reflects the beam emitted from the light source 100 onto the display device 122; and an emission prism 125b which transmits the beam reflected by the display device 122 to the projection lens unit 130.

As shown in FIG. 1B, the illumination lens system 120 is composed of first through fourth lenses 120a, 120b, 120c, and 120d. The exemplary design data of the first through fourth lenses 120a, 120b, 120c, and 120d is shown in Table 1. Here, R denotes a radius curvature, Dn denotes the thickness of a lens or the distance between lenses, N denotes a refractive index, and v denotes an Abbe's number.

TABLE 1

| Lens | Curvature | Thickness or | Refractive | Abbe's |
|---|---|---|---|---|
| Side | Radius (R) | Distance (Dn) | Index (N) | Number (v) |
| 0 | ∞ | 3.50 | | |
| S1 | −9.91000 | 6.00 | 1.51680 | 64.2 |
| S2 | −10.42700 | 0.10 | | |
| S3 | ∞ | 5.00 | 1.51680 | 64.2 |
| S4 | −21.60000 | 33.00 | | |
| S5 | ∞ | 6.50 | 1.52500 | 64.2 |
| S6 | −23.19962 | 65.80 | | |
| S7 | 98.28100 | 8.00 | 1.51680 | 64.2 |
| S8 | −54.76600 | 2.00 | | |
| S9 | ∞ | 22.64 | 1.51680 | 64.2 |
| S10 | ∞ | 0.00 | 1.51680 | 64.2 |
| S11 | ∞ | −21.62 | 1.51680 | 64.2 |
| S12 | ∞ | −4.80 | | |
| S13 | ∞ | −2.74 | 1.47200 | 66.1 |
| S14 | ∞ | −0.78 | | |
| SIM | ∞ | | | |

The side S6 is aspherical whose definition is as follows.

When the X-axis is set as the optical axis in FIG. 1B, and the Y-axis is set as a perpendicular direction from the optical axis, a forward direction of the beam is positive and can be expressed as described below. Here, x denotes a distance from the vertex of a lens to the optical axis, y denotes a distance toward the perpendicular direction from the optical axis, K denotes a conic constant, A, B, C, and D denote coefficients of an aspherical surface, and c denotes a reciprocal number (1/R) of the refractive radius in the vertex of lens.

$$x = \frac{{cy}^{2}}{1 + \sqrt{1 - ( K + 1 ) {c}^{2} {y}^{2}}} + {Ay}^{4} + {By}^{6} + {Cy}^{8} + {Dy}^{10} \qquad ( 10 )$$

Coefficients of the aspherical side S8 are K=0.0, A=0.112753E-04, B=−0.665984E-8, C=0.112495E-9, and D=−0.262361E-12. In Table 1, S9, S10, S11, S12, S13, and S14 indicate the respective sides of the total reflection prism 125 and the display device 122.

Referring to FIG. 2, calculation of the chromatic aberration of the illumination lens system of FIG. 1B is based on five fields a, b, c, d, and e when the beam is emitted from the integrator 117. The coordinates of each field are shown in Table 2.

TABLE 2

| | a | b | c | d | e |
|---|---|---|---|---|---|
| X coordinate | 0.00000 | −1.09602 | −3.92444 | 1.09602 | 3.92444 |
| Y coordinate | 0.00000 | 3.92444 | 1.09602 | −3.92444 | −1.09602 |

With reference to the aberration diagram of FIG. 2, even if the conventional illumination lens system employs an expensive aspherical lens, chromatic aberration still occurs. The chromatic aberration results in a reduction of an illumination margin when the beam emitted from the integrator 117 is irradiated onto the display device 122. That is, a beam that is output from the integrator 117 and has a shape corresponding to the shape of the display device 122 must be uniformly irradiated onto the display device 122. However, a large amount of chromatic aberration reduces the beam which is effectively irradiated onto the display device 122, thereby lowering image quality.

The conventional illumination system further costs a great deal of money due to its use of an aspherical surface.

### SUMMARY OF THE INVENTION

An exemplary embodiment of present invention provides an illumination lens system, in which chromatic aberration and expenses are reduced, and a projection system including the illumination lens system.

According to an aspect of the present invention, there is provided a projection system comprising: a light source; a color filter separating beams emitted from the light source into colored beams; an illumination lens system comprising first through third lens groups that condense the colored beams, the second lens group comprising a double lens comprising a first lens having a highly disperse and negative refractive power and a second lens having a low disperse and positive refractive power; a display device processing the beam emitted from the illumination lens system in response to an input signal and forming a color image; and a projection lens unit enlarging the color image formed by the display device and projecting the color image onto a screen.

The projection system further comprising a total reflection prism between the illumination lens system and the display device condensing the beam emitted from the illumination lens system toward the display devices, and directing the beam reflected by the display device toward the projection lens unit.

The projection system further comprising a concave mirror between the illumination lens system and the display device condensing the beam emitted from the illumination lens system onto the display device.

According to another aspect of the present invention, there is provided an illumination lens system that is employed in a projection system and condenses a beam emitted from a light source onto a display device that forms an image, comprising: first through third lens groups, the second lens group comprising, a double lens comprising a first lens having a highly disperse and negative refractive power and a second lens having a low disperse and positive refractive power.

When f1 is the effective focal distance of the first lens group, f3 is the effective focal distance of the third lens group, and d is the distance between the principal plane of the first lens group and the principal plane of the third lens group, the illumination lens system may satisfy the following conditions:

$$0.8 \leq \frac{d}{{f}_{1} + {f}_{3}} \leq 1.2$$

The projection system may further include a beam shaper that shapes the beam emitted from the light source so that the beam has a cross-sectional shape corresponding to the shape of the display device, where m is the size of the beam emitted from the display device, f1 is the effective focal distance of the first lens group, and f3 is the effective focal distance of the third lens group, such that the illumination lens system satisfies the following condition:

$$0.8 m \leq \frac{{f}_{3}}{{f}_{1}} \leq 1.2 m$$

In an exemplary embodiment, the illumination lens system may comprise only spherical lenses.

### BRIEF DESCRIPTION OF THE DRAWINGS

The above aspects and features of the present invention will become more apparent by describing in detail exemplary embodiments thereof with reference to the attached drawings in which:

FIG. 1A is a schematic diagram of a conventional projection system;

FIG. 1B is a schematic diagram of an illumination lens system included in the projection system illustrated in FIG. 1A;

FIG. 2 is a diagram illustrating fields used to calculate chromatic aberration of the illumination lens system illustrated in FIG. 1B;

FIG. 3 the chromatic aberration of the illumination lens system illustrated in FIG. 1B;

FIG. 4A is a schematic diagram of a projection system according to an embodiment of the present invention;

FIG. 4B illustrates a modified example of the projection system according to an embodiment of the present invention;

FIG. 5 is a schematic diagram of an illumination lens system according to a first exemplary embodiment of the present invention;

FIG. 6 illustrates the chromatic aberration of the illumination lens system illustrated in FIG. 5.

FIG. 7 is a schematic diagram of an illumination lens system according to a second exemplary embodiment of the present invention;

FIG. 8 illustrates the chromatic aberration of the illumination lens system of FIG. 7.

FIG. 9 is a schematic diagram of an illumination lens system according to a third exemplary embodiment of the present invention;

FIG. 10 illustrates the chromatic aberration of the illumination lens system illustrated in FIG. 9.

FIG. 11 is a schematic diagram of an illumination lens system according to a fourth exemplary embodiment of the present invention;

FIG. 12 illustrates the chromatic aberration of the illumination lens system illustrated in FIG. 11.

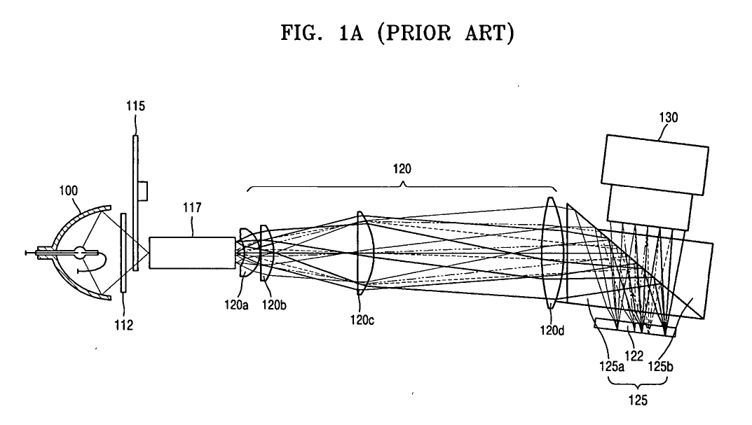

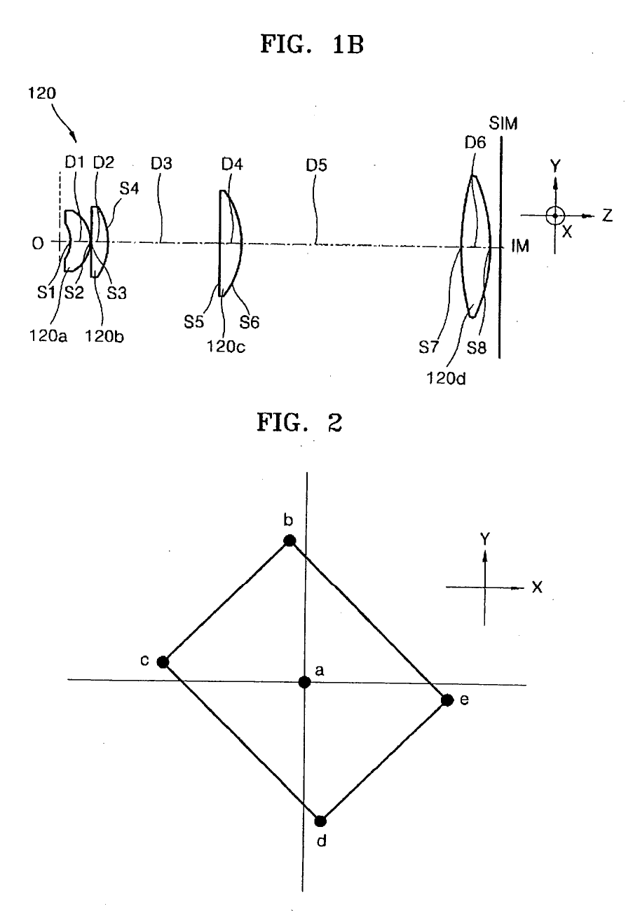

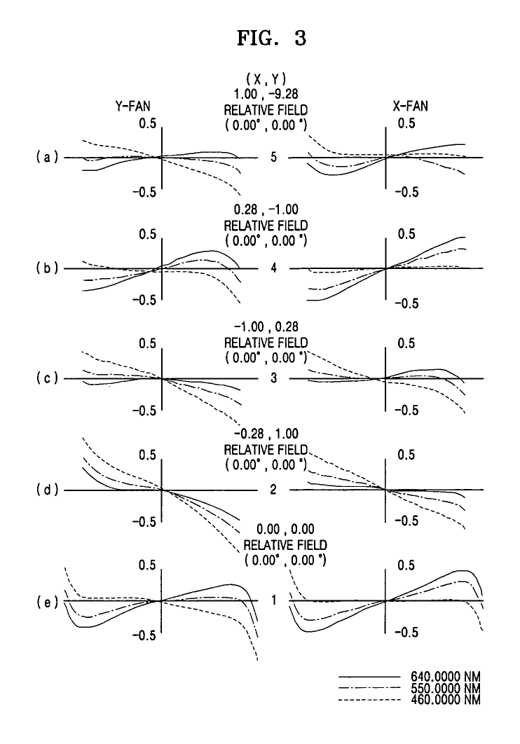

### DETAILED DESCRIPTION OF EXEMPLARY EMBODIMENTS OF THE INVENTION

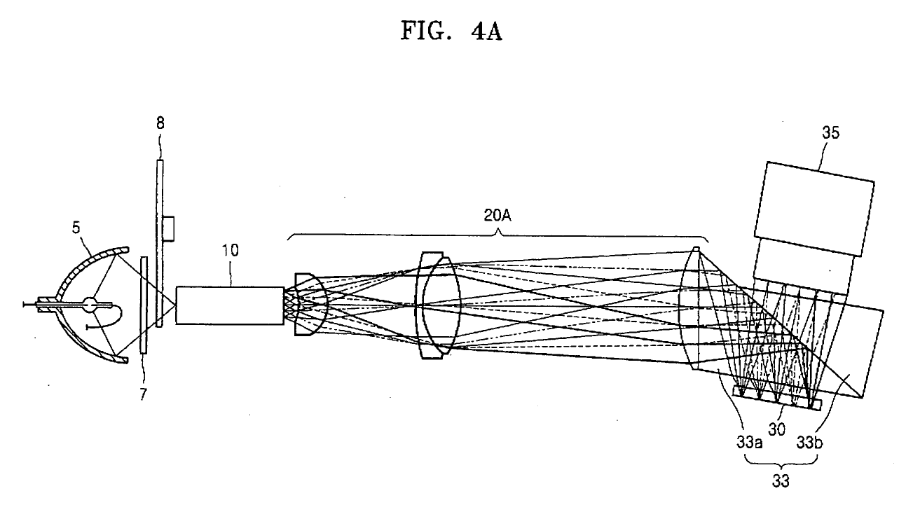

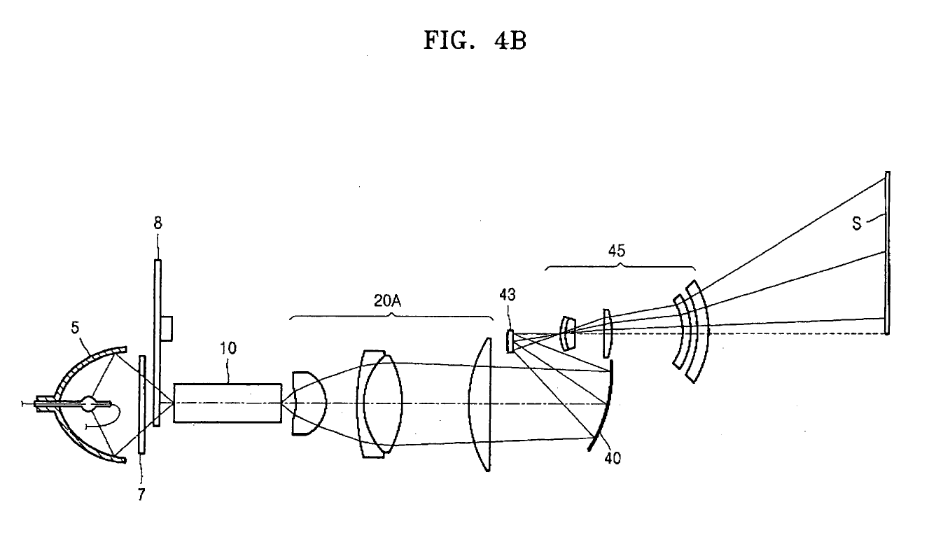

Referring to FIG. 4A, the projection system includes a light source 5; a color filter 8 which separates light emitted from the light source 5 into colored beams; and a display device 30 which processes the colored beams passing through the color filter 8 in response to an input signal and forms a color image. A projection lens unit 35 enlarges and projects the color image formed in the display device 30 onto a screen (not shown).

The color filter 8 may be, for example, a color wheel. An ultraviolet filter 7 is disposed on the light path between the light source 5 and the color filter 8, and a beam shaper 10 that shapes the beam emitted from the light source 5 is disposed on the light path between the color filter 8 and the display device 30. The beam shaper 10 may be an integrator, a light tunnel, or a glass rod. The beam shaper 10 shapes the beam so that the beam has a cross-sectional shape corresponding to the shape of the display device 30 and a uniform intensity.

A total reflection prism 33 directs the beam emitted by the beam shaper 10 toward the display device 30, and directs the beam reflected by the display device 30 toward the projection lens unit 35.

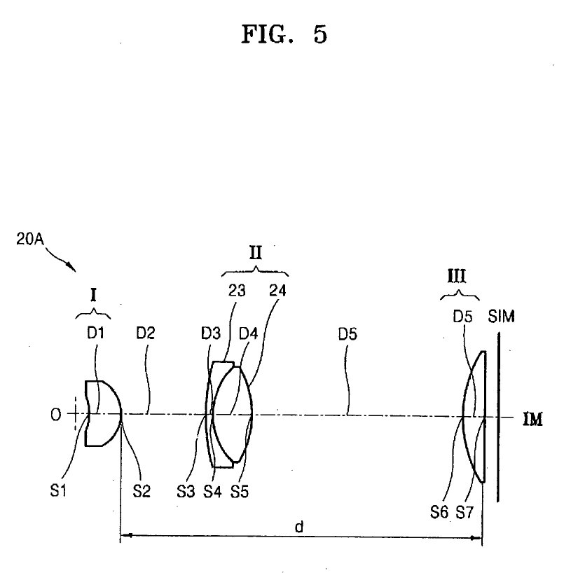

With additional reference to FIG. 5, an illumination lens system 20A including first through third lens groups I, II, and III condenses beams on a light path between the beam shaper 10 and the total reflection prism 33. The second lens group II includes a double lens including a first lens 23 having a highly disperse negative refractive power and a second lens 24 having a low disperse positive refractive power.

The total reflection prism 33 creates different optical paths for the beam incident on the display device 30 and the beam reflected by the display device 30. The total reflection prism 33 may have first and second prisms 33a and 33b opposite each another. The first prism 33a, which is an incidence prism, totally reflects the incident beam directly onto the display device 30, and the second prism 33b, which is an emission prism, transmits the beam reflected by the display device 30 directly to the projection lens unit 35.

Alternatively, as shown in FIG. 4B, the total reflection prism 33 may include a concave mirror 40 that reflects and condenses the beam emitted from the illumination lens system 20A onto a display device such that the display device 43 emits light along an optical axis parallel to the optical axis of the illumination lens system 20A. A projection lens unit 45 enlarges and projects a color image formed by the display device 43 onto a screen S.

The display devices 30 and 43 may be reflection type liquid crystal displays (LCDs) or deformable micromirror devices (DMDs).

Although not shown in the figures, at least one light-path converter which changes the path of the colored beams is disposed between the color filter 8 and the display device 30 or 43.

Referring to FIG. 5, the illumination lens system 20A according to an exemplary embodiment of the present invention includes the first through third lens groups I, II, and III which are disposed from an objective side to an image side. The second lens group II includes a double lens comprising a first lens 23 having a highly disperse and negative refractive power and a second lens 24 having a low disperse and positive refractive power.

When the effective focal distance of the first lens group I is f1, the effective focal distance of the third lens group I is f3, and the distance from the principal plane of the first lens group I to the principal plane of the first lens group III is d, the illumination lens system 20A may satisfy the following conditions:

$$0.8 \leq \frac{d}{{f}_{1} + {f}_{3}} \leq 1.2 \qquad ( 2 )$$

When the illumination lens system 20A has a value bigger than the maximum value, the beam incident on the display device 30 has such a large amount of diversion that the illumination lens system 20A departs from the telecentric system. When the illumination lens system 20A has a value smaller than the minimum value, the beam incident on the display device 30 has such a large amount of condensation that the illumination lens system 20A is not utilized.

When the ratio of the size of the beam incident on the illumination lens system 20A and the size of the beam emitted from the display device 30 is m, the illumination lens system 20A may satisfy the following condition:

$$0.8 m \leq \frac{{f}_{3}}{{f}_{1}} \leq 1.2 m \qquad ( 3 )$$

If the illumination lens system 20A has a value exceeding the maximum value, the beam incident on the display device 30 has such a large amount of radiation that the illumination lens system 20A cannot be utilized. If the illumination lens system 20A has a value smaller than the minimum value, the beam incident on the display device 30 has a very large amount of condensation.

The design data of an illumination lens system 20A according to a first exemplary embodiment of the present invention is as follows.

Here, R denotes a radius of curvature of a lens, Dn (n is a natural number) denotes the thickness of a lens or the distance between lenses, N denotes a refractive index, and v denotes an Abbe's number.

TABLE 3

| Lens | Curvature | Thickness or | Refractive | Abbe's |
|---|---|---|---|---|
| Side | Radius (R) | Distance (Dn) | Index (N) | Number (v) |
| 0 | ∞ | 4.04 | | |
| S1 | −27.75407 | 10.00 | 1.65844 | 50.9 |
| S2 | −11.79481 | 26.00 | | |
| S3 | 58.25637 | 2.00 | 1.72825 | 28.3 |
| S4 | 20.25800 | 11.70 | 1.58913 | 61.3 |
| S5 | −29.91033 | 64.21 | | |
| S6 | 37.82266 | 6.40 | 1.51680 | 64.2 |
| S7 | ∞ | 19.69 | 1.51680 | 64.2 |
| S8 | ∞ | 0.00 | 1.51680 | 64.2 |
| S9 | ∞ | −22.74 | 1.51680 | 64.2 |
| S10 | ∞ | −3.00 | | |
| S11 | ∞ | −3.00 | 1.47200 | 66.1 |
| S12 | ∞ | −0.47 | | |
| SIM | ∞ | | | |

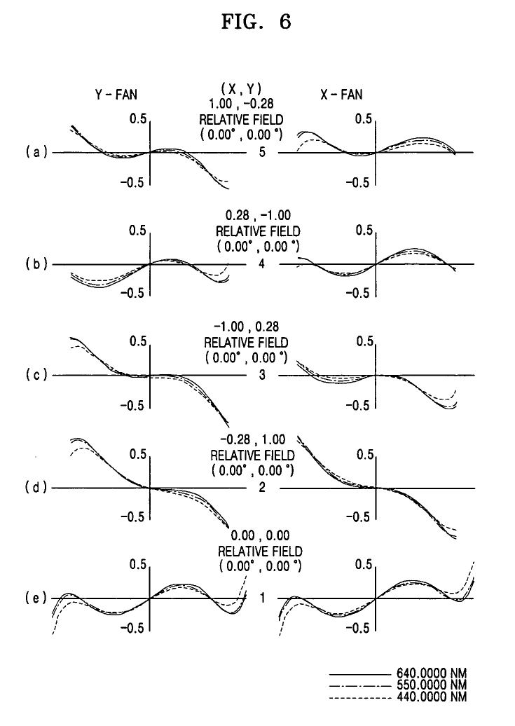

In Table 3, S8, S9, S10, S11, and S12 indicate the respective surfaces of the total reflection prism 33 and the display device 30. FIG. 6 illustrates the chromatic aberration of the illumination lens system 20A shown in FIG. 5. The chromatic aberration is obtained when a lens is imaged in the display device 30, 43.

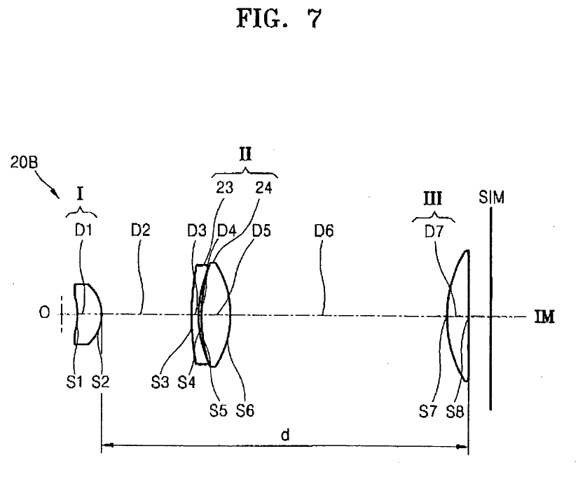

An illumination lens system 20B according to a second exemplary embodiment of the present invention is illustrated in FIG. 7. The design data of the illumination lens system 20B illustrated in FIG. 7 is as follows.

TABLE 4

| Lens | Curvature | Thickness or | Refractive | Abbe's |
|---|---|---|---|---|
| Side | Radius (R) | Distance (Dn) | Index (N) | Number (v) |
| 0 | ∞ | 4.826505 | | |
| S1 | −22.05139 | 7.00 | 1.74397 | 44.9 |
| S2 | −11.17675 | 26.00 | | |
| S3 | 74.12738 | 2.00 | 1.75520 | 27.6 |
| S4 | 34.74362 | 0.77 | | |
| S5 | 46.77763 | 8.29 | 1.66162 | 53.4 |
| S6 | −29.04246 | 62.88 | | |
| S7 | 37.82266 | 6.40 | 1.56124 | 63.9 |
| S8 | 435.18490 | | | |
| SIM | ∞ | | | |

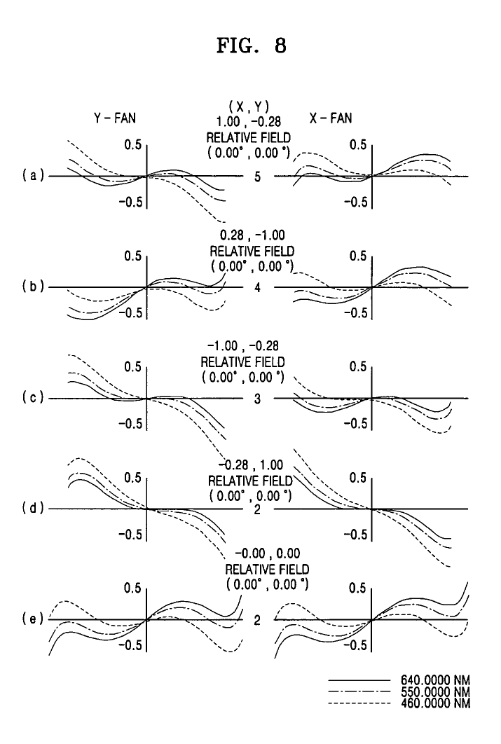

FIG. 8 illustrates the chromatic aberration of the illumination lens system 20B illustrated in FIG. 7. Although the illumination lens system 20B does not use an aspherical surface, the chromatic aberration is improved.

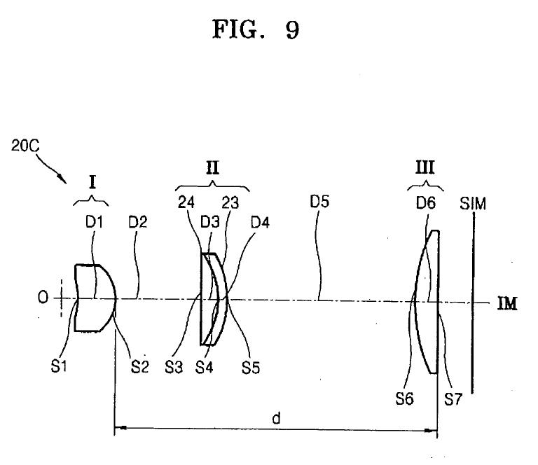

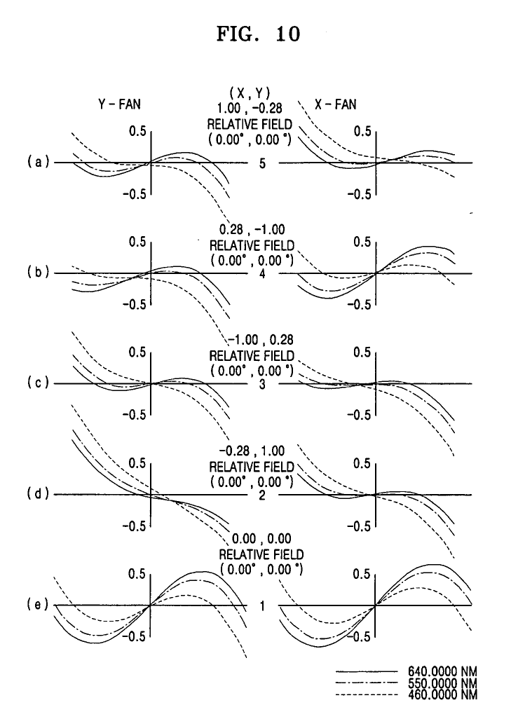

FIG. 9 illustrates an illumination lens system 20C according to a third exemplary embodiment of the present invention. The exemplary design data of the illumination lens system 20C illustrated in FIG. 9 is as follows.

TABLE 5

| Lens | Curvature | Thickness or | Refractive | Abbe's |
|---|---|---|---|---|
| Side | Radius (R) | Distance (Dn) | Index (N) | Number (v) |
| 0 | ∞ | 4.00 | | |
| S1 | −28.99107 | 10.00 | 1.74428 | 44.1 |
| S2 | −11.42240 | 23.00 | | |
| S3 | −254.05314 | 4.19 | 1.71251 | 47.6 |
| S4 | −21.72603 | 2.00 | 1.75520 | 27.6 |
| S5 | −27.77453 | 50.009 | | |
| S6 | 42.61221 | 5.89 | 1.74397 | 44.6 |
| S7 | ∞ | | | |
| SIM | ∞ | | | |

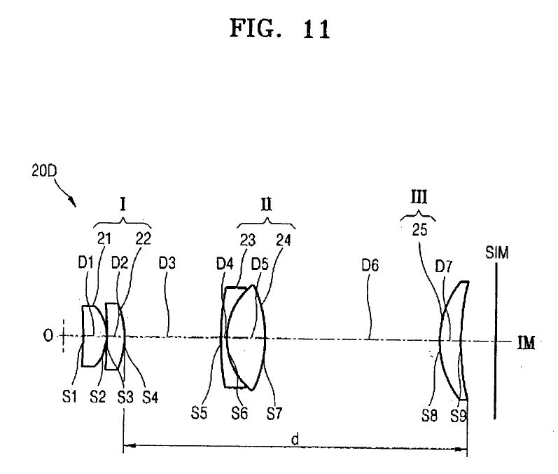

FIG. 10 illustrates the chromatic aberration of the illumination lens system 20C illustrated in FIG. 9.

FIG. 11 is a schematic diagram of an illumination lens system 20D according to a fourth exemplary embodiment of the present invention. Table 6 indicates exemplary design data of the illumination lens system 20D illustrated in FIG. 11. In the fourth embodiment of the present invention, a first lens group I includes a first lens 21 and a second lens 22, a second lens group II includes a third lens 23 and a fourth lens 24, and a third lens group III includes a fifth lens group 25.

TABLE 6

| Lens | Curvature | Thickness or | Refractive | Abbe's |
|---|---|---|---|---|
| Side | Radius (R) | Distance (Dn) | Index (N) | Number (v) |
| 0 | ∞ | 6.00 | | |
| S1 | −56.34802 | 8.00 | 1.55828 | 64.1 |
| S2 | −13.06447 | 0.10 | | |
| S3 | −69.95719 | 5.00 | 1.74589 | 40.5 |
| S4 | −30.53232 | 30.13 | | |
| S5 | 95.49207 | 2.00 | 1.75520 | 27.6 |
| S6 | 21.65923 | 11.700 | 1.65748 | 54.0 |
| S7 | −38.88080 | 55.00 | | |
| S8 | 31.18209 | 6.40 | 1.55756 | 48.0 |
| S9 | 89.53555 | 2.00 | | |
| S10 | ∞ | | | |
| SIM | ∞ | | | |

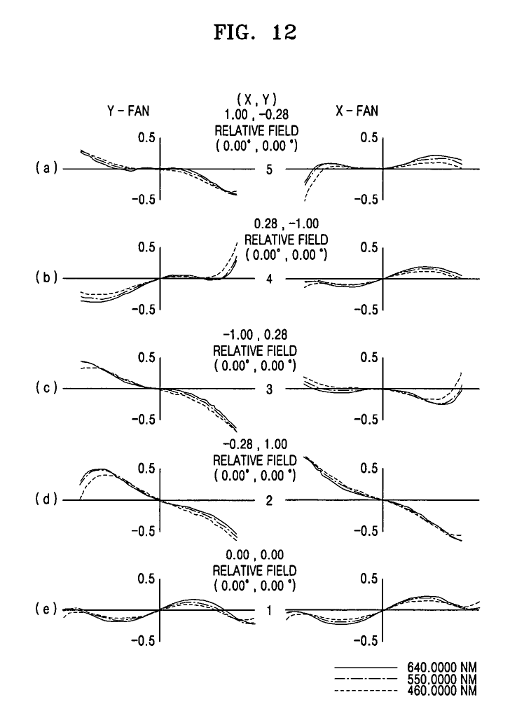

FIG. 12 illustrates the chromatic aberration of the illumination lens system 20D according to the fourth embodiment of the present invention.

It can be seen from FIG. 12 that the chromatic aberration is greatly improved in the illumination lens system 20D illustrated in FIG. 11. The chromatic aberration is improved without using an aspherical lens, and therefore expenses are reduced and an increased illumination margin of the beam irradiated on the display device is obtained.

As described above, the illumination lens system according to the exemplary embodiments of the present invention can improve the chromatic aberration without using an aspherical lens, resulting in a reduction in the manufacturing expenses.

In a projection system including an illumination lens system with improved chromatic aberration, an illumination margin of a beam incident on a display device is increased, and therefore the performance of the illumination projection system is improved and image quality is improved.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A projection system comprising:
a light source;
a color filter which separates beams emitted from the light source into colored beams;
an illumination lens system comprising a first lens group, a second lens group and a third lens group that condense the colored beams, the second lens group comprising a double lens comprising a first lens having a highly disperse and negative refractive power and a second lens having a low disperse and positive refractive power;
a display device which processes a beam emitted from the illumination lens system in response to an input signal and provides a color image; and
a projection lens unit which enlarges the color image provided by the display device and projects the color image onto a screen.

2. The projection system of claim 1, wherein where f1 is an effective focal distance of the first lens group, f3 is an effective focal distance of the third lens group, and d is a distance between a principal plane of the first lens group and a principal plane of the third lens group, the illumination lens system satisfies the following condition:
$$0.8 \leq \frac{d}{{f}_{1} + {f}_{3}} \leq 1.2$$

3. The projection system of claim 1, comprising a beam shaper disposed on a light path between the color filter and the display device.

4. The projection system of claim 3, wherein where m is the ratio of a size of a beam emitted in the beam shaper and a size of a beam emitted from the display device, f1 is the effective focal distance of the first lens group, and f3 is an effective focal distance of the third lens group, the illumination lens system satisfies the following condition:
$$0.8 m \leq \frac{{f}_{3}}{{f}_{1}} \leq 1.2 m$$

5. The projection system of claim 1, further comprising a total reflection prism between the illumination lens system and the display device which condenses the beam emitted from the illumination lens system toward the display device, and directs a beam reflected by the display device toward the projection lens unit.

6. The projection system of claim 1, further comprising a concave mirror between the illumination lens system and the display device which condenses the beam emitted from the illumination lens system onto the display device.

7. The projection system of claim 1, wherein the illumination lens system comprises only spherical lenses.

8. An illumination lens system that is employed in a projection system and condenses a beam emitted from a light source onto a display device that forms an image, comprising:
a first lens group, a second lens group and a third lens group, the second lens group comprising, a double lens comprising a first lens having a highly disperse and negative refractive power and a second lens having a low disperse and positive refractive power.

9. The illumination lens system of claim 8, wherein where f1 is an effective focal distance of the first lens group, f3 is an effective focal distance of the third lens group, and d is a distance between a principal plane of the first lens group and a principal plane of the third lens group, the illumination lens system satisfies the following conditions:
$$0.8 \leq \frac{d}{{f}_{1} + {f}_{3}} \leq 1.2$$

10. The illumination lens system of claim 8, wherein the projection system further includes a beam shaper that shapes the beam emitted from the light source so that the beam has a cross-sectional shape corresponding to a shape of the display device, and m is a size of a beam emitted from the display device, f1 is an effective focal distance of the first lens group, and f3 is an effective focal distance of the third lens group, the illumination lens system satisfies the following condition:
$$0.8 m \leq \frac{{f}_{3}}{{f}_{1}} \leq 1.2 m$$

11. The illumination lens system of claim 8, wherein the illumination lens system comprises only spherical lenses.
